(19) United States
(12) Patent Application Publication
(10) Pub. No.: US 2017/0106838 A1
(43) Pub. Date: Apr. 20, 2017

(54) PEDAL BODY FOR AN ACTUATION PEDAL OF A MOTOR VEHICLE

(71) Applicant: BOGE Elastmetall GmbH, Damme (DE)

(72) Inventors: Daniel Rieskamp, Ibbenbüren (DE); Burkhard Tiemann, Bad Essen (DE); Keit Wagener, Bissendorf (DE); Jan Duetz, Wangerland (DE); Leonhard Wedel, Osnabrück (DE)

(21) Appl. No.: 15/301,055

(22) PCT Filed: Apr. 2, 2015
(86) PCT No.: PCT/EP2015/057339

§ 371 Date: Dec. 21, 2016

(30) Foreign Application Priority Data
Apr. 3, 2014 (DE) 102014206386.8

(51) Int. Cl. B60T 7/06; B60K 23/02; B29C 45/14; G05G 1/405; G05G 1/50; B60K 26/02; G05G 1/44

(52) U.S. Cl. CPC B60T 7/06; B60K 26/02; B60K 23/02; G05G 1/44; G05G 1/405; G05G 1/506; B29C 45/14336; B29L 2031/30

(57) ABSTRACT

An actuation pedal of a motor vehicle includes a pedal body, an adjustment apparatus and a mount for mounting the adjustment apparatus to the pedal body. The pedal body includes a beam and a filling material, the filling material formed by stiffening members arranged in the interior of the beam. An adjustment apparatus includes an adjustable actuation tread. The mount is surrounded by the beam and formed by a cylindrical cut-out at a side of the beam facing the actuation tread and by a corresponding hollow cylindrical portion in the filling material.

### FIELD OF THE INVENTION

The invention relates to a pedal body for an actuation pedal of a motor vehicle, in particular for an actuation pedal for actuating a braking system, wherein the pedal body comprises a beam having stiffening members arranged therein.

### BACKGROUND OF THE INVENTION

An actuation pedal having such a pedal body is known, for example, from DE 10 2011 003 222 A1. The stiffening members in the pedal body serve the improvement of the bending and twisting stiffness of the actuation pedal.

Such an actuation pedal can be manufactured inexpensively. However, in this construction, separate or differently dimensioned actuation pedals are required for each pedal system or in dependence on the available construction space. An actuation pedal would, however, be desirable that can be adapted to different systems or environments.

Pedal systems having adjustable pedal arms are known from U.S. Pat. No. 6,584,871 B3 and from EP 0 982 645 A2. The adjustment takes place via an arc curve or via a linear adjustment device. It is inter alia disadvantageous in these systems that the total pedal arm has to be considered in the adjustment. A pedal system is known from U.S. Pat. No. 6,345,550 B1 in which only the pedal surface is adjustable. The complexity of the design, the resulting total weight and the manufacturing effort are, however, also disadvantageous in this system.

### SUMMARY OF THE INVENTION

The object is to avoid or at least alleviate these disadvantages.

This object is achieved by the invention set forth in the independent claims. Advantageous embodiments can be seen from the dependent claims.

In accordance with the invention, a pedal body is provided for an actuation pedal of a motor vehicle, in particular for an actuation pedal for actuating a braking system, said pedal body comprising a beam, wherein the beam surrounds a mount for an actuation tread of the actuation pedal.

The present invention is based on the recognition that a compact adjustable actuation pedal can be provided that is simple to manufacture due to an integration of the mount in the beam of the pedal body. The requirement for an adjustment and adaptation of the actuation pedal to different environments is in particular already provided by the pedal body in accordance with the invention without additional production steps being necessary in the manufacture of the pedal body.

The beam advantageously comprises stiffening members arranged therein that likewise surround the mount. The mount is in this respect preferably fixedly connected to the beam. In this case, the connection can be configured with shape matching, force transmission or material continuity.

In an embodiment of the invention, the mount for the adjustment apparatus is formed by one of the stiffening members. In other words, the mount can be configured such that it increases the twisting stiffness and/or bending stiffness of the pedal body. This embodiment is characterized by an efficient utilization of the available construction space. The mount is hollow cylindrical, for example.

In an embodiment of the pedal body, the beam is formed by a fiber-reinforced polymer sheet. The fiber-reinforced polymer sheet contributes to the establishing of the desired stiffness. To achieve an even higher stiffness, the beam can also comprise parts of sheet metal and/or steel and/or aluminum (hybrid construction).

The stiffening members form a filling material and can consist of plastic. Such a filling material can in particular be manufactured in a simple manner by injection molding. The filling material additionally has a low weight.

The pedal body can comprise parts for a connection or a connector or a holder for supply lines for the adjustment apparatus. Supply lines for the adjustment apparatus can thus be laid within the pedal body in a space-saving manner.

In accordance with a further aspect of the present invention, an actuation pedal is provided comprising a pedal body of the above-described kind and comprising an adjustment device having an adjustable actuation tread. Such an actuation pedal is suitable for adaptation to different pedal systems and construction spaces. The actuation pedal can therefore be adapted to different vehicle types.

The adjustment apparatus can comprise a hydraulic or pneumatic drive or a mechanical spindle drive. Flexibility is provided with respect to the selection of the suitable drive due to the construction of the actuation pedal.

In an embodiment, the adjustment apparatus has a cylindrical hollow body that is arranged with force transmission in the mount, with a displaceable piston being arranged in the cylindrical hollow body that is connected via a push rod to the actuation tread disposed outside the cylindrical hollow body, with the actuation tread being displaceable and settable by displacing the piston substantially perpendicular to the actuation thread and/or transversely to the longitudinal extent of the pedal body. Such an adjustment device has a favorable ratio of compactness and adjustability.

In a further embodiment of the invention, the adjustment apparatus comprises a sensor for determining the position of the actuation tread. The sensor can be integrated in the drive and can, for example, determine the angle of rotation of a drive shaft or output shaft of the drive. Alternatively or additionally, an external sensor can be provided that determines the adjustment distance of the push rod, for example.

The sensor signal is transmitted to a central control unit in the motor vehicle. The control unit processes the sensor signal. The control unit can in particular determine the position of the actuation tread from the angle of rotation and from the gear ratio. The control unit optionally generates a control signal to actuate the drive and to adjust the actuation tread. A so-called memory function can be implemented for the actuation tread in this manner. Memory functions are known per se from the area of seat adjustment and are therefore not described in any more detail.

The required supply lines for the sensor system can be laid within the pedal body in a space-saving and protective manner so that no additional holders have to be provided. The present actuation pedal thus allows a particularly simple and inexpensive establishing of a memory function.

In accordance with a further aspect of the present invention, a method is provided for manufacturing a pedal body for an actuation pedal of a motor vehicle, in particular for an actuation pedal for actuating a braking system, said method comprising: introducing a beam into an injection mold, wherein the beam is open at one side; back injection molding the beam using a plastic for shaping stiffening members in the inner space of the beam; and injecting plastic for shaping a mount for an adjustment apparatus for an actuation tread of the actuation pedal. In accordance with this method, the pedal body in accordance with the invention can be manufactured in a few steps. The molding of the stiffening members and of the mount can take place in an injection molding step.

Parts for a connection, a connector or a holder for supply lines for the adjustment apparatus can be molded on in the same manufacturing step. No subsequent installation effort such as the welding on of holders is therefore required.

### BRIEF DESCRIPTION OF THE DRAWINGS

FIG. 1 an actuation pedal with an adjustment apparatus 2 with a pedal plate 3 in accordance with an embodiment of the invention;

FIG. 2 the actuation pedal 1 of FIG. 1 with a representation of the stiffening members;

FIG. 3 a cross-section through the actuation pedal of FIG. 1; and

FIG. 4 a rear view of the actuation pedal 1 of FIG. 1.

### DETAILED DESCRIPTION OF THE INVENTION

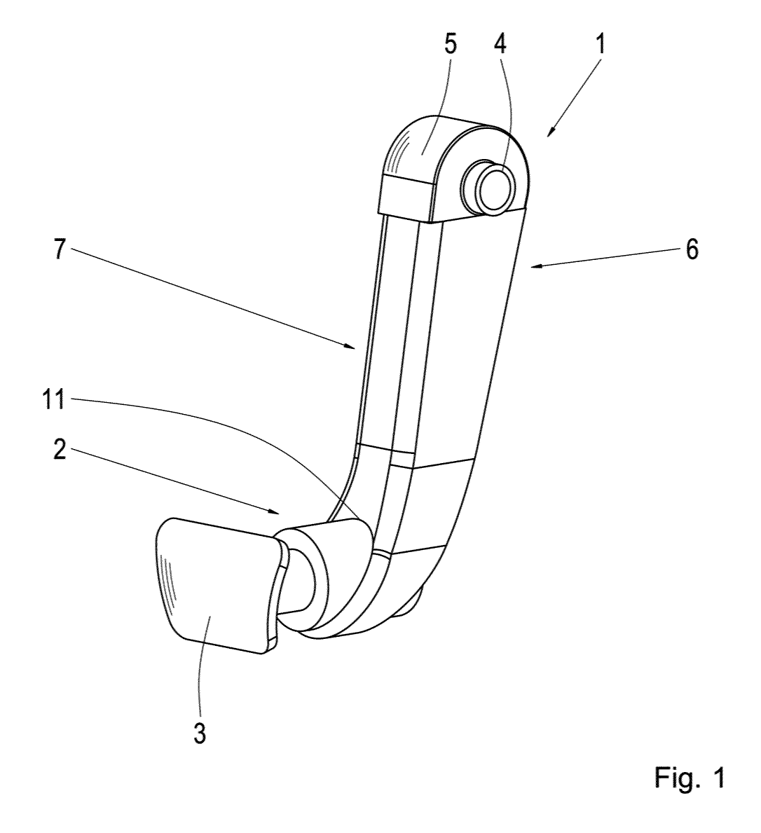

FIG. 1 shows an actuation pedal 1 having an adjustment apparatus 2 with a pedal plate 3 in accordance with an embodiment of the invention. The actuation pedal 1 comprises a bearing bushing 4 for a pivotable connection of the actuation pedal 1 to a pedal block (not shown) of a motor block fixed to the body. The bearing bushing 4 forms a part of a plastic head 5 of the actuation pedal 1.

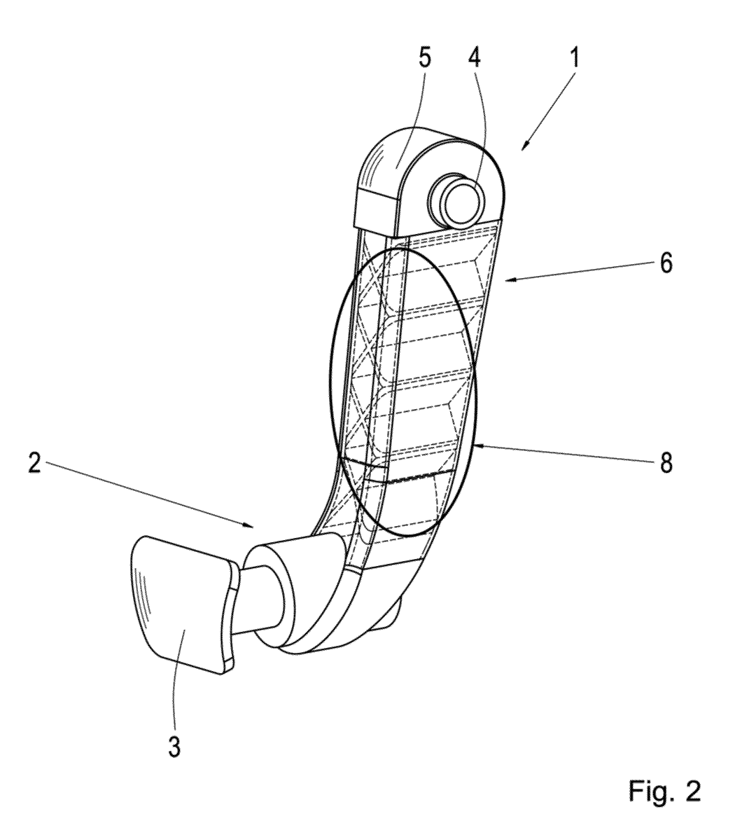

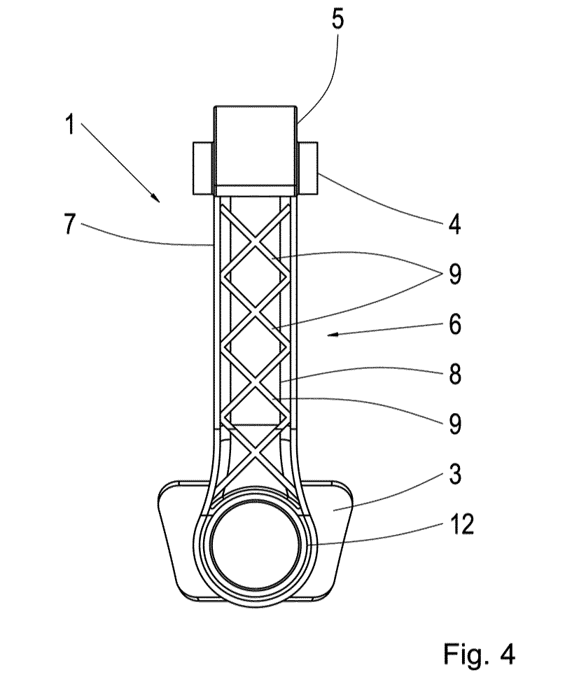

As shown in FIGS. 2, 3 and 4, the actuation pedal 1 comprises a pedal body 6 having a beam 7. A filling material 8 for stiffening the pedal body 6 is arranged in the interior of the beam 7. The filling material 8 comprises a honeycomb structure that is formed in cross-section from mutually contacting, diamond-shaped stiffening portions 9.

The beam 7 consists of a deep-drawn cut section of a long-fiber reinforced or continuous-fiber reinforced thermoplastic plate. The beam 7 is open at its rear side, i.e. at its side remote from the pedal plate 3.

The filling material 8 is manufactured by injection molding, with the beam 7 being placed into the injection mold. In other words, the beam 7 is back-injection molded by the stiffening portions 9, with the beam 7 and the stiffening portions 9 being connected to one another with material continuity. The resulting pedal body 6 is characterized by high bending stiffness and torsional stiffness.

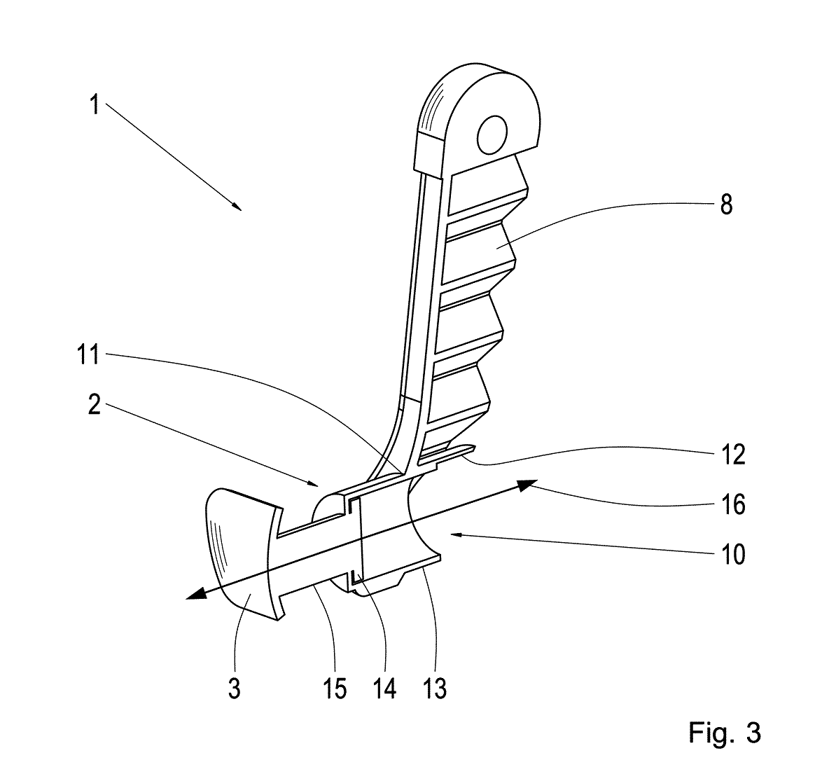

The pedal body 6 has a mount 10 (FIG. 3) for the adjustment apparatus 2. The mount 10 is formed by a cylindrical cut-out 11 at the front side, i.e. at the side of the beam 7 facing the pedal plate 3, and by a corresponding hollow cylindrical portion 12 in the filling material 8. The mount 10 is located at the end of the pedal body 6 at the bottom with respect to the drawing.

The hollow cylindrical section 12 is manufactured together with the stiffening portions 9 of the beam 7 in a single injection molding step. The pedal body 6 having the mount 10 for the adjustment device 2 can thus be simply manufactured. The hollow cylindrical section 12 additionally contributes to the stiffness of the pedal body 6.

The adjustment apparatus 2 comprises a cylindrical hollow body 13 that is arranged with frictional fit in the mount 10. A drive motor (not shown) is provided in the hollow body 13 to displace a piston 14 axially. The piston 14 is connected to the pedal plate 3 via a push rod 15. The pedal surface can be brought into a desired position and set by displacing the piston 14 and the push rod 15. The travel distance extends substantially perpendicular to the pedal plate 3 and is shown by the arrow 16 in FIG. 3.

A mechanical spindle drive can be provided in the hollow body 13 as a drive for the piston 14. In this respect, the spindle can be driven directly via an electrical linear motor. Alternatively, the spindle can be connected to the linear motor via a flexible shaft. Such a drive is known per se and is therefore not further explained. In alternative embodiments, the drive takes place hydraulically or pneumatically.

All required supply lines for the drive, e.g. electrical, hydraulic or pneumatic lines, can extend in a space-saving manner within the pedal body 6. All the holder parts possibly required for this purpose can in this respect be formed with the filling material 8, i.e. they can be manufactured together with the filling material 8 in a single injection molding step. After the demolding of the pedal body 6, the plastic head 5 and the adjustment apparatus 2 can be assembled after which the actuation pedal 1 is ready for assembly to the pedal block.

### REFERENCE NUMERALS

1 actuation pedal
2 adjustment apparatus
3 pedal plate, actuation tread
4 bearing bushing
5 plastic head
6 pedal body
7 beam
8 filling material
9 diamond-shaped reinforcement portions
10 mount
11 cylindrical cut-out
12 hollow cylindrical section
13 cylindrical hollow body
14 piston
15 push rod
16 displacement direction

1.-16. (canceled)

17. An actuation pedal of a motor vehicle, comprising:
a pedal body having a beam and a filling material, the filling material formed by stiffening members arranged in an interior of the beam;
an adjustment apparatus having an adjustable actuation tread; and
a mount for mounting the adjustment apparatus to the pedal body, the mount formed by a cylindrical cut-out at a side of the beam facing the actuation tread and by a corresponding hollow cylindrical portion in the filling material, the mount being surrounded by the beam.

18. An actuation pedal in accordance with claim 17, wherein the corresponding hollow cylindrical portion is one of the stiffening members.

19. An actuation pedal in accordance with one of the claim 17, wherein the mount is a hollow cylindrical mount.

20. An actuation pedal in accordance with claim 17, wherein the beam is formed by a fiber-reinforced polymer sheet or element.

21. An actuation pedal in accordance with claim 17, wherein the beam is formed at least partly from sheet metal and/or steel and/or aluminum.

22. An actuation pedal in accordance with claim 17, wherein the stiffening members are formed of plastic and are manufactured by injection molding.

23. An actuation pedal in accordance with claim 17, wherein the pedal body includes parts for a connection or a connector or a holder for supply lines for the adjustment apparatus.

24. An actuation pedal in accordance with claim 23, wherein with the parts for a connection or a connector or a holder are manufactured by injection molding from plastic.

25. An actuation pedal in accordance with claim 17, wherein the adjustment apparatus includes a hydraulic or pneumatic drive or a mechanical spindle drive.

26. An actuation pedal in accordance with claim 17, wherein the adjustment apparatus further includes a cylindrical hollow body arranged in the mount with frictional fit and a displaceable piston arranged in the cylindrical hollow body of the adjustment apparatus and connected via a push rod to the actuation tread disposed outside the cylindrical hollow body, the actuation tread being displaceable and settable by displacing the piston substantially perpendicular to the actuation tread and/or transversely to a longitudinal axis of the pedal body.

27. An actuation pedal in accordance with claim 26, further comprising a sensor for determining a parameter that reproduces a position of the actuation tread and for transmitting a sensor signal to a control apparatus of the motor vehicle.

28. An actuation pedal in accordance with claim 27, wherein supply lines for the adjustment apparatus and/or for the sensor extend at least partly within the pedal body.

29. A method of manufacturing an actuation pedal of a motor vehicle, comprising the steps of:
introducing a beam into an injection mold, wherein the beam has an inner space and is open at one side;
back injection molding the beam using a plastic for shaping stiffening members in the inner space of the beam; and
injecting plastic for shaping a mount for an adjustment apparatus for an actuation tread of the actuation pedal.

30. A method in accordance with claim 29, wherein the shaping of the stiffening members and of the mount takes place in an injection molding step.

31. A method in accordance with claim 29, wherein the shaping of the stiffening members including a molding of parts for a connection or a connector or a holder for supply lines for the adjustment apparatus.
